(19) United States
(12) Patent Application Publication
(10) Pub. No.: US 2008/0284173 A1
(43) Pub. Date: Nov. 20, 2008

(54) Wave Energy Apparatus

(76) Inventors: Peter Kenneth Stansby, Cheshire (GB); Alan Charles Williamson, Lancs (GB); Nicholas Jenkins, Lancs (GB)

Correspondence Address: MCANDREWS HELD & MALLOY, LTD, 500 WEST MADISON STREET, SUITE 3400, CHICAGO, IL, 60661, US

(21) Appl. No.: 11/911,445

(22) PCT Filed: Apr. 7, 2006
(86) PCT No.: PCT/GB2006/001278

§ 371 Date: Jul. 10, 2008

(30) Foreign Application Priority Data
Apr. 14, 2005 (GB) 0507554.4

(51) Int. Cl. F03B 13/14

(52) U.S. Cl. 290/53

(57) ABSTRACT

Apparatus for extracting waves comprises a float (6) coupled to a drive mechanism (2) such that vertical movement of the float can be used to generate power. The float is freely suspended in a body of water, but subject to a flexible restraint (10, 12, 14) system for restricting its lateral movement. The restraint system can itself involve a suspended mass (10), which may be another float (6) coupled to the same or a different drive mechanism (2).

This invention relates to the generation of power from the motion of sea waves, and particular to apparatus and methods of the kind described in International Patent Application No PCT/GB2004/004393 (now Publication No WO 2005/038244); our earlier application, to which reference is directed.

Our earlier application discloses apparatus in which the vertical movement of a float or float device in a body of water is operatively linked to a drive mechanism for a power generator. The apparatus is adapted to exploit the benefits that can be obtained by substantially matching the natural frequency of vertical oscillation of the body with the frequency of the cyclic movement of water in which the float is suspended. At resonance, the vertical movement of the body can exceed by a significant amount, the vertical movement of the body of water itself.

In the use of apparatus of the kind described in our earlier application, best results are obtained with the movement of the float being subject to minimal restraint. However, some horizontal or lateral restraint is required. Our earlier application proposes the use of tethers which allow the float to rise and fall under the action of large waves, but constrain its position sufficiently to permit optimal operation of the drive mechanism. The present invention is directed at apparatus broadly of this kind, but using a variety of techniques for restricting lateral movement of the float in the body of water in which it is immersed.

Apparatus according to the invention comprises a support structure with a drive mechanism for a power generator with a flexible suspension depending from the support structure. A float is attached to the suspension for immersion in a body of sea water, and for vertical movement in response to movement of water in the body, with such movement being operatively linked to the drive mechanism. Lateral movement of the float in the body of water is restricted by means of a restraint system which couples the float to at least one element that is itself resiliently restrained relative to the structure. In an alternative arrangement, the restraint system comprises a resiliently flexible element coupling the float to a remote fixture. By providing resilient restraint, less strain is put on the coupling unit or mechanism, and movement of the body in different lateral directions can be better accommodated.

Resilient restraint on the lateral movement of the float can as noted above, be provided by elasticity in the member or members that couple the float to one or more remote fixtures. However, in preferred embodiments of the invention the coupling is to a suspended mass, and more particularly to the means suspending such mass. Conveniently, the mass can be suspended from the same structure as the float, but this is certainly not essential. It is though, preferred to ensure that the means suspending the mass is itself flexible, typically as a cable or rope, or even a hinged rod. With this assembly, by coupling the float to an intermediate section of the cable, rope or hinged rod, usually at the hinge, progressively increasing resistance to lateral movement of the float is provided by very simple means.

In order to minimise wobbling of the float in the water, two vertically spaced levels on the float can be coupled to the restrained element. This can preserve the attitude of the float in its preferred vertical alignment, and with the resilient restraint, sudden movements of the float are inhibited.

Apparatus according to the invention can be extended to include a plurality of floats which co-operate to mutually restrain their lateral movement. In these circumstances, the apparatus creates its own restraint system, and no additional restraint element is required. Thus, a restrained element is effectively replaced by another suspended float operatively linked to the drive mechanism. Such floats may be arranged in an array, all operatively linked to the drive mechanism, or a number of drive mechanisms. Generally though, at least one of the suspended floats in a group of floats is coupled to at least one restrained element other than a float.

The drive mechanism for a power generator to which movement of the float is operatively linked can take any suitable form, and that described in our earlier application is typical of one that might be used. Where the apparatus comprises a number of floats, the drive mechanism will, of course, be adapted to accommodate float movements at different locations, but the location of floats can be aligned so that movement of a number of them can be linked to a common drive shaft. Alternatively or additionally, multiple drive shafts may be employed associated with the same or different power generators.

Some embodiments of the invention will now be described by way of example, and with reference to the accompanying schematic drawings wherein:

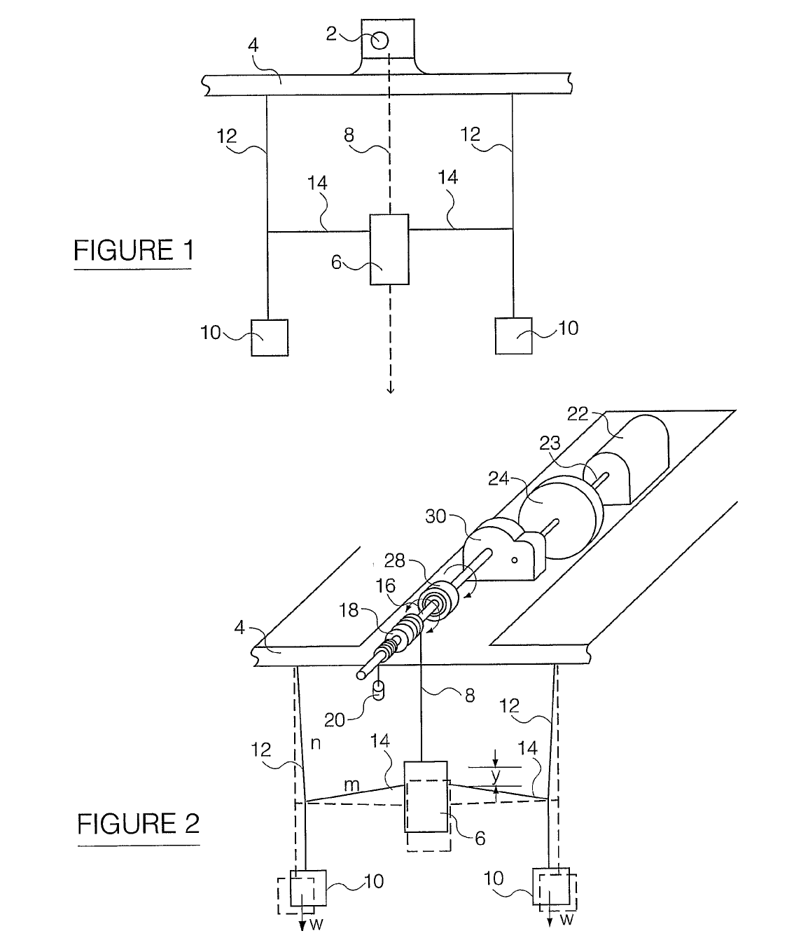

FIG. 1 is a diagrammatic illustration of a float suspended between two suspended masses;

FIG. 2 is a view of the arrangement of FIG. 1 showing the consequences of vertical movement of the float and a drive mechanism coupled thereto;

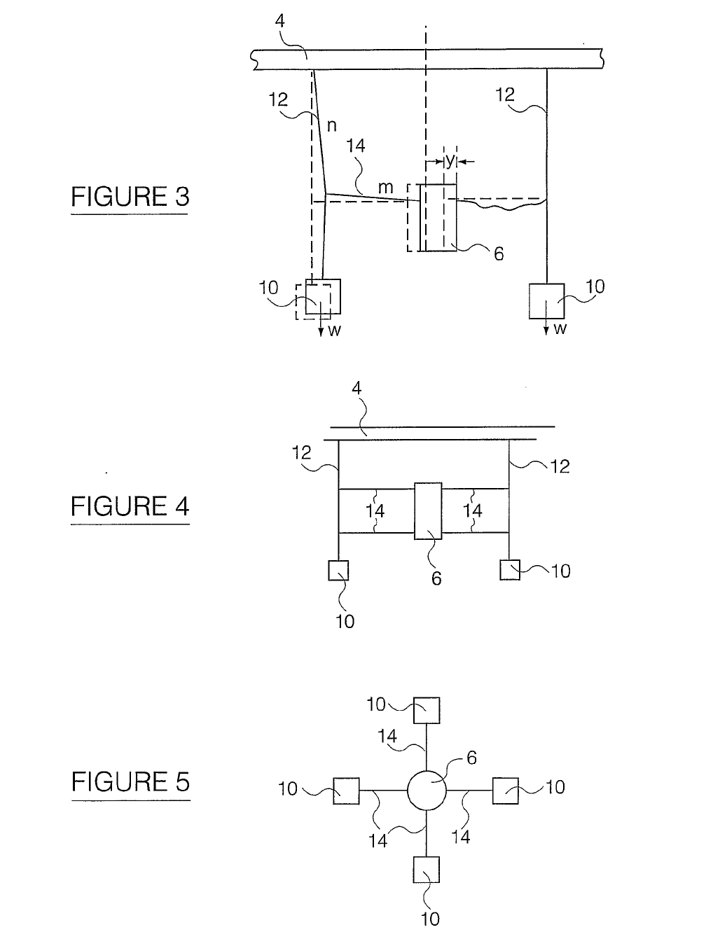

FIG. 3 is a further illustration of the arrangement of FIG. 1 demonstrating the consequences of lateral movement of the float;

FIG. 4 illustrates an arrangement in which the float is restrained at vertically separated locations;

FIG. 5 is a plan view showing how the lateral movement of a float can be restrained in two dimensions;

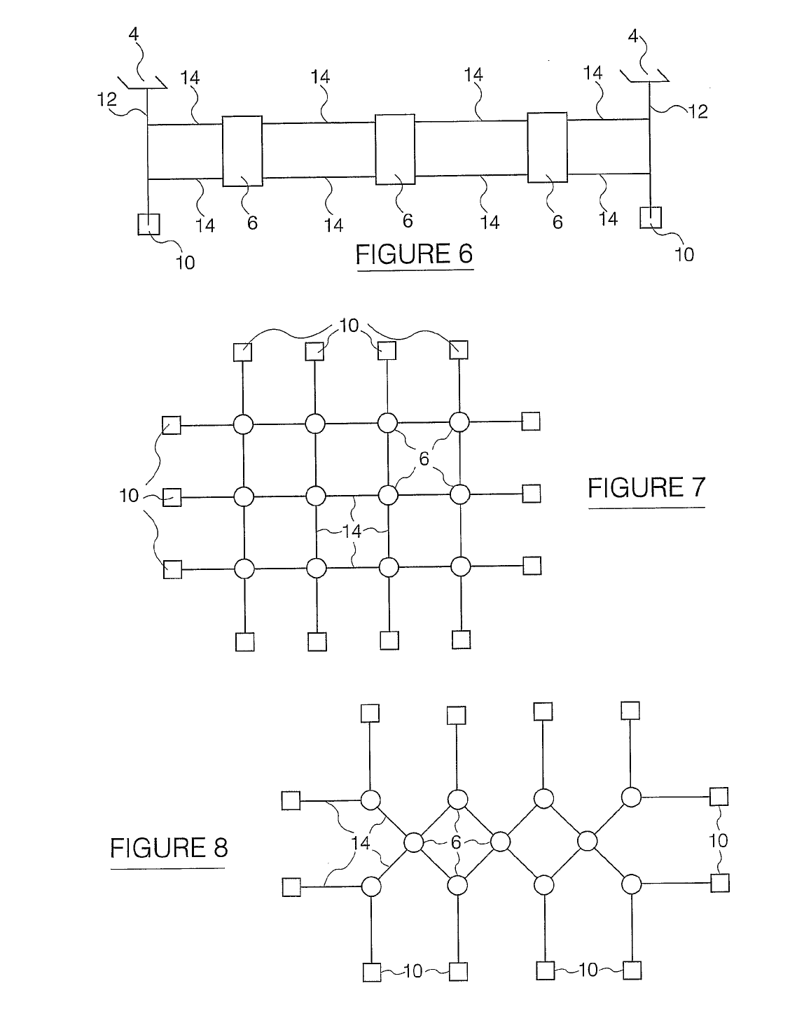

FIG. 6 illustrates an arrangement including a plurality of floats;

FIGS. 7 and 8 are plan views showing arrays of floats and alternative orientations relative to restrained elements; and

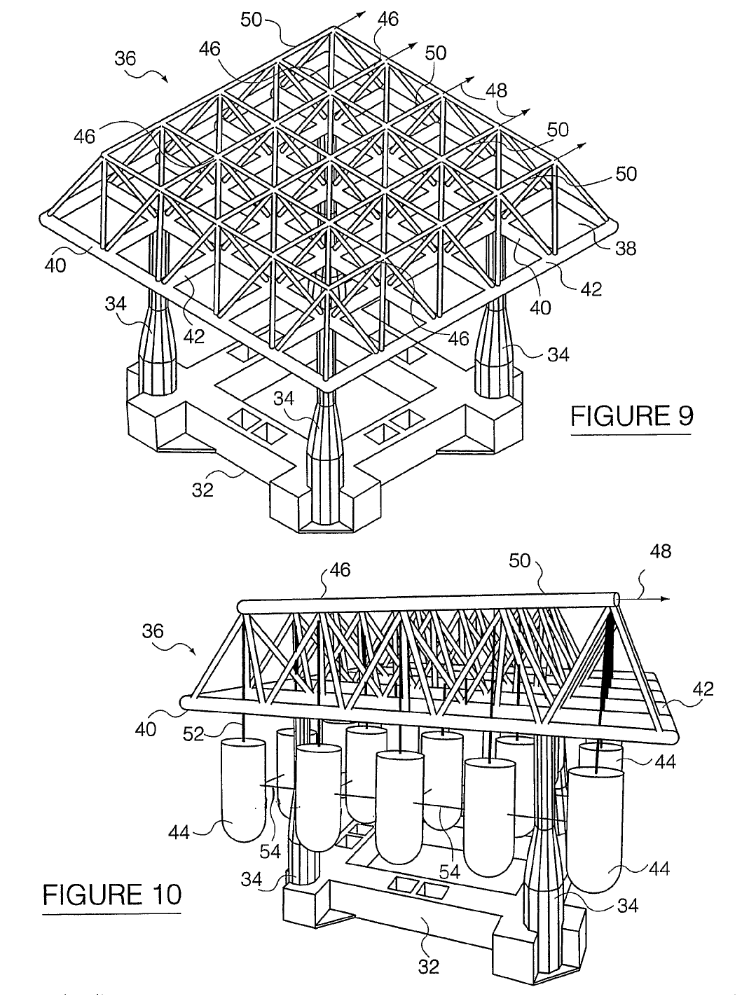

FIG. 9 shows an offshore structure for an array of floats for coupling to a plurality of drive mechanisms; and

FIG. 10 shows a side view of the structure of FIG. 9 with floats suspended therefrom.

In the arrangement of FIG. 1, a float 6 depends from the support structure 4 on a cable 8 that is wound on a drive shaft 2 of a drive mechanism, mounted on a support structure 4. When immersed in a body of water subject to wave motion, the float 6 will rise and fall with the waves, which rise and fall will be converted into rotation of the shaft 2. This rotation is then converted into usable power by means of a generator or other device.

Also shown in FIG. 1 are two masses 10 suspended from the support structure by cables 12. Further cables or tethers 14 extend from either side of the float 6 to a point on the cables 12 between the respective mass 10 and the support structure 4, but a central location is not essential, although usual. There are, though, circumstances in which it will be preferred to attach the tethers 14 to the cables 12 at points closer to the masses 10 than to the support structure.

The arrangement illustrated in FIG. 1 allows the float 6 to move with relative freedom vertically below the shaft 2. However, the tethers 14 attached to the cables 12 resist lateral movement to an extent which is determined by the weight of the masses 10. Although illustrated in a plane perpendicular to the axis of the shaft 2, in apparatus of the invention tethers will normally provide restraint more generally against lateral movement of the float, and in at least three horizontal directions from the float.

FIG. 2 shows the arrangement of FIG. 1 after some upward vertical movement of the float 6. With a vertical displacement y of the float, the force on the float opposing its vertical displacement can be calculated as:

$$F = \frac{2 {xy}^{3}}{2 {xm}^{2} n} W$$

if y is small compared with n and m. Thus, in order to minimise the resistance to vertical motion consequential upon the use of the restraint mechanism disclosed, it will be appreciated that the length m of the tether and n of the distance from the support structure along the cables 12 to the junctions with the tethers 14 should be as large as possible.

FIG. 3 illustrates the consequences of lateral movement of the float in the arrangement of FIG. 1. For a lateral displacement X the restraining force M can be calculated as:

$$M = \frac{x}{n} W$$

if x is small compared with m and n.

For example: let m=3n; y=0.1n; and x=0.1n,

then F=1.1×10⁻⁴ W; and M=0.1 W

thus for those chosen lengths and equal excursions, the lateral restraining force generated by the restraint system is 1000 times the restraining force the system exerts against vertical movement of the float.

FIG. 2 also shows how the movement of the float 6 is coupled to a drive mechanism on the support structure 4 for power generation. The cable 8 transmits motion to a drive shaft 16 via a pulley 18. As the body 10 rises a counterweight 20 takes in the slack in the suspending component 14 by rotating the pulley 18. A separate mechanism might be employed instead for this purpose. The drive shaft 16 is connected to an electricity generator 22 through a clutch/freewheel device 28. The clutch 28 is caused to engage and disengage the connection of the drive shaft 16 with an electricity generator 22. Thus, the clutch/freewheel 28 allows the electricity generator 22 to rotate in the direction opposite to that of the pulley 18 as the body 10 rises. The mechanism shown also includes a separate flywheel 24, which provides extra inertia on the drive shaft 16. At the peak of a wave, the body 10 starts to descend under the action of gravity, and the pulley 18 begins to rotate in the same direction as the electricity generator 22. At some time during the fall of the body 10 the speed of the pulley 18, which is enhanced by resonance, becomes equal to that of the electricity generator 22 and, under these conditions, the freewheel device 28 engages so that the increasing downwards velocity of the body 10 causes the speed of the electricity generator 22 to increase. When the body 10 ceases its downward acceleration as a result of interaction with the water surface the freewheel device 28 is disengaged, allowing the flywheel 24 and electricity generator 22 to continue their rotation as the pulley 18 decelerates to zero speed. The cycle then commences to repeat as the water surface rises and starts to lift the body 10. If the electricity generator 22 and the flywheel 24 are together designed with sufficient moment of inertia, then useful power may be extracted during the entire cycle with the speed of the electricity generator 22 falling during the interludes between the acceleration periods, but remaining high enough to keep the generating capability through the cycle.

By using the gearbox 30 to increase the speeds of the generator 22 and flywheel 24, for example to speeds in excess of 1000 rev/min, the size of both generator 22 and flywheel 24 can be reduced for a given energy extraction per cycle. The freewheel device can be placed either between pulley and gearbox, or between gearbox and generator and flywheel.

In a typical apparatus according to the invention, a concrete float 6 of around 10 metres diameter and around 4 metres height, and weighing around 400 tonnes will be suspended between three suspended restraining masses 10, each weighing about 150 tonnes. The counterweight will also be around 150 tonnes in weight. Steel cables will normally be used to suspend the float and restraining masses, and for the tethers 14, but cables of other materials including synthetic materials such as polypropylene may be used, depending upon what characteristics are required. Different materials will provide different elasticity and maintenance, as weight can also be a factor. Chains could be used, with the possible advantage of an inherent damping facility between links. Also rigid rods or tubes, restrained collinearly, may be used as a restraining element where damping material or mechanisms between components generates damping due to their relative motion.

FIG. 4 illustrates an arrangement in which multiple tethers 14 are applied to the float 6. This arrangement controls the attitude of the float in the water, but again with minimal restraint on its vertical movement.

FIGS. 1 to 4 illustrate restraint systems in two dimensions only. In a body of water, of course, there will be a third dimension with lateral restraint having to be accomplished in two dimensions. FIG. 5 illustrates how this can readily be accomplished using four suspended masses 10. Three suspended would also, of course, be sufficient. The greater the number of suspended masses used, the more constrained will be the float 6 against lateral movement. However many suspended masses are used, it will be appropriate to arrange them symmetrically around the float 6.

While the examples discussed above all use suspended masses as the principal component to the restraint system, it will be appreciated that similar resilient resistance to lateral movements may be created by means of a resilient tie or tether which may be designed to have inherent damping extending between the float and either the support structure or another stationary fixture. This could comprise a spring, or inherent elasticity in the tie or tether. This arrangement could be appropriate in situations where the apparatus is located relatively close to land.

FIG. 6 shows how a number of floats 6 can be used to restrain each other against lateral movement within what is shown as a line of floats with a suspended mass 10 at either end. If such a line of floats were used, then the floats would, of course, need to be restrained against lateral movement in the perpendicular direction (normal to the paper), but preferably a plurality of floats will be used in an array of the kind shown in FIGS. 7 and 8. FIG. 7 shows a multitude of floats arranged in a square array in which each float 6 is constrained by tethers 14 in four perpendicular directions. FIG. 8 shows a diamond array in which floats 6 within the array are constrained in four directions with floats at the periphery constrained in three. The common feature between the arrays illustrated is that a restraint system is located along the or each boundary of the array. However, depending on the number of floats and their arrangement in an array, this separate restraint system can be unnecessary. In each of the arrays of FIGS. 7 and 8 tethers or linking cables 14 may be attached to the floats at different levels, as shown in FIGS. 3 and 6.

The arrays illustrated in FIGS. 7 and 8 are only examples of float arrangements that might be used. Arrays of many shapes and sizes can be created, with individual groups or cells being coupled to different drive mechanisms for power generation.

FIG. 9 shows an offshore structure for supporting an array of floats in a body of seawater. The structure will be towed out to the chosen site, and then sunk to locate the base 32 on the seabed. The four concrete columns 34 support the framework 36 from which the floats (not shown in this Figure) are suspended. The framework 36 defines individual cells 38 on a platform itself defined by horizontal beams 40 and 42. A pyramid is formed over each cell, and a float 44 is suspended from the apex 46 of each pyramid, as shown in FIG. 10.

In the structure shown in FIG. 9, the framework 36 defines twenty-five cells in which twenty-five floats 44 will be suspended in a square array. Each float will normally be coupled to an individual drive mechanism, but floats in a row of floats can be coupled to a common drive mechanism (not shown), as indicated by the arrows 48, along a respective common overhead shaft 50. Each mechanism can be broadly similar to that described above with reference to FIG. 2.

FIG. 10 illustrates the location of the floats relative to the framework 36, suspended by cables 52 from the apices 46 of the cell pyramids. The floats 44 form a square array, with each float coupled to adjacent floats by tethers 54. Multiple tethers of the kind illustrated in FIGS. 4 and 6 can be used to provide additional stability. As the floats rise and fall in the body of water, their lateral movement is restrained by the tethers and normally, this mutual restraint is sufficient also to control lateral movement of the peripheral floats. However, additional restraint mechanisms of the type referred to above can be included, conveniently comprising additional masses suspended from the outermost beams 40 and 42.

The structure shown will typically have columns 34 around 60 metres in height, and be suitable for installation in seawater having a depth of around 40 metres.

1. Apparatus for generation of power from the motion of sea waves, comprising a support structure with a drive mechanism for a power generator; a flexible suspension depending from the support structure; a float attached to the suspension for immersion in a body of sea water and for vertical movement in response to movement of water in the body, such movement being operatively linked to the drive mechanism; and a flexible restraint system for restricting lateral movement of the float in said body of water, which restraint system couples the float to at least one element resiliently restrained relative to the structure.

2. Apparatus according to claim 1 wherein said at least one element of the restraint system comprises a suspended mass.

3. Apparatus according to claim 2 wherein the float and said at least one element are suspended from the support structure.

4. Apparatus according to claim 2 wherein the float is coupled to the means suspending said at least one element.

5. Apparatus according to claim 1 wherein at least two vertically separated points on the float are coupled to said at least one element.

6. Apparatus according to claim 1 wherein the flexible suspension for the float comprises a cable, and the float is coupled to said at least one element by at least one further cable.

7. Apparatus according to claim 1 wherein said at least one element is another suspended float operatively linked to drive mechanism.

8. Apparatus according to claim 7 comprising an array of suspended floats operatively linked to the drive mechanism.

9. Apparatus according to claim 7 comprising an array of suspended floats of which each is operatively linked to a separate drive mechanism.

10. Apparatus according to claim 7 wherein at least one suspended float is coupled to at least one restrained element other than a float.

11. Apparatus according to claim 8 wherein at least one float at the boundary of the array is coupled to at least one restrained element other than a float.

12. Apparatus for generation of power from the motion of sea waves, comprising a support structure with at least one drive mechanism for a power generator; a flexible suspension system depending from the support structure; and an array of floats each attached to the suspension system for immersion in a body of sea water and for vertical movement in response to movement of water in the body, such movement being operative linked to a said drive mechanism, each float being coupled to an adjacent float to provide restraint against lateral movement thereof.

13. Apparatus according to claim 12 wherein adjacent floats are coupled by a flexible linkage.

14. Apparatus according to claim 13 wherein adjacent floats are coupled by a plurality of flexible linkages connected to each respective float at points thereon vertically spaced from one another.

15. Apparatus for generation of power from the motion of sea waves, comprising a support structure with a drive mechanism for a power generator; a flexible suspension depending from the support structure; a float attached to the suspension for immersion in a body of sea water and for vertical movement in response to movement of water in the body, such movement being operatively linked to the drive mechanism; and a flexible restraint system for restricting lateral movement of the float in said body of water, which restraint system comprises a resiliently flexible element coupling the float to a remote fixture.

16. Apparatus according to claim 15 wherein the element is elastically extendible.

17. Apparatus according to claim 15 wherein the element is a spring.

18. Apparatus according to claim 15 wherein the remote fixture is fixed relative to the support structure.

19. Apparatus according to claim 9 wherein at least one float at the boundary of the array is coupled to at least one restrained element other than a float.
